(19) United States
(12) Patent Application Publication
(10) Pub. No.: US 2017/0201170 A1
(43) Pub. Date: Jul. 13, 2017

(54) METHOD FOR GENERATING HIGHLY EFFICIENT HARMONICS FREE DC TO AC INVERTERS

(71) Applicant: AHMED FAYEZ ABU-HAJAR, PULLMAN, WA (US)

(72) Inventor: AHMED FAYEZ ABU-HAJAR, PULLMAN, WA (US)

(73) Assignee: AHMED FAYEZ ABU-HAJAR, PULLMAN, WA (US)

(21) Appl. No.: 15/469,540

(22) Filed: Mar. 26, 2017

(51) Int. Cl. H02M 1/12; H02M 3/156; H02M 7/538

(52) U.S. Cl. CPC H02M 1/12; H02M 7/53803; H02M 3/156; H02M 2001/0009

(57) ABSTRACT

This invention presents a highly efficient harmonics free DC-AC power inverter using a pair of push-pull switches with feedback loop that acts as a voltage regulator. The feedback loop voltage regulator uses a series-shunt feedback amplifier to regulate the output voltage by amplifying the error signal between a pure sine wave referenced signal and the measured output voltage signal. A step-up low power transformer is used to step-up the triggering pulse at gates of the push-pull solid state switches to the desired rated output voltage so that the output voltage becomes harmonic free sine wave, but high voltage feedback amplifier, if feasible, maybe used without using the transformer. The reference signal may be synchronized with the grid for on grid applications, but it can also be used for stand alone loads. In order to optimally minimized the conduction power loss across the push-pull solid state switches of the DC-AC inverter, the positive voltage V+ and the negative voltage V− must be regulated and controlled, so that the voltage across the push-pull switches are minimized. Hence, two DC-DC converters are used to generate the regulated voltages V+ and V−. Each of those voltages is controlled using a feedback loop that drives the pwm of the DC-DC converter. At this point, the conduction power loss of the DC-AC push-pull solid state switches are optimally minimized, but the DC-DC converters are not. In order to minimize the conduction power loss of the DC-DC converters, two multilevel converters with n-array series voltage sources, or n-array series capacitors, are used. The voltage level at the top of each capacitor is carefully selected so that the overall conduction power loss of the DC-DC converters is minimized. The power conduction power loss proportional to the number of levels used but this comes at higher cost and complexity.

### CROSS-REFERENCE TO RELATED APPLICATIONS

Pending: Ser. No. 15/272,922

### BACKGROUND OF THE INVENTION

This invention pertains generally to the field of electrical power conversion and particularly to DC-to-AC inverters using solid state switches. In this invention, a highly efficient harmonics free sine wave at the output of DC to AC inverters is generated without using bulky transformers and or bulky inductors to smooth out ripples and suppress harmonics. Instead, this invention uses a voltage regulator with a pure sine wave as a reference in a feedback loop to generate precise triggering pulses at solid state switches. The precise triggering pulses generate harmonics free sine wave at the output. To make this inverter highly efficient in term of power losses, this invention minimizes the voltage drop across the switches in two steps. In the first step, the voltage across push-pull solid state switches of the DC-AC inverter are minimized by using two DC-DC converters. The first DC-DC converter generates a positive controlled half wave voltage and the second DC-DC converter generates a negative half wave voltage. Hence, a precise voltage across the switch is achieved to optimally minimize the power conduction losses across each push-pull DC-AC inverter switch. Those voltages are controlled using non-linear pwm technique in a feedback configuration in order to provide minimum voltages across each of the DC-AC transistors. The non-linear pwm automatically adjusts the width as well as the frequency of the signal in order to generate an optimally minimized and controlled voltage across the precisely triggered switches of the DC-AC inverter. In the second step, the power conduction across each of the DC-DC converter switches is achieved by using multilevel voltage sources, or an array of source capacitors in series, such that the voltage levels are carefully selected to minimize the overall power conduction losses. Each voltage level has its designated switch and its designated triggering pulse. The voltage levels and the conduction time interval for each voltage level is carefully selected to minimize the overall power conduction losses across all the switches.

### BRIEF SUMMARY OF THE INVENTION

Current state-of-the-art DC-AC inverters use pulse width modulation techniques combined with multilevel inverters to generate near sinusoidal output at 60 Hz, 50 Hz or 400 Hz. However, the generated output contains high levels of harmonies due to the finite number of levels with ON-OFF switching. Removing all harmonics requires expensive filters and/or large inductors combined with advanced pwm techniques.

In this invention, a harmonics free sinusoidal voltage at the output is generated using a sinusoidal voltage regulator in a feedback loop. The voltage regulator sends a precise triggering pulse to the solid state push-pull switches of the DC-AC inverter, for example the gates of MOSFETs, such that the generated output is pure sine wave. Hence, a harmonies free sinusoidal power signal is generated at the output because of the feedback loop of the regulator. However, the power dissipated across the switch is not optimal, as the voltage across the switch is not controlled. In this invention, the voltage across the two complementary push-pull solid state switches (NMOS & PMOS) using two multilevel DC-DC converters in which their voltages are constantly changing to minimize the conduction power losses across all the switches. This requires the use two feedback loops, one for each DC-DC converter, which generate varying frequency and pulse width that depends on the input voltage level and the desired output voltage level and conduction time interval of each DC-DC converter. In this invention, a feedback system, that can be analog and/or digital, is used to adjust the voltage across the switches such that the overall conduction power loss is minimized.

### BRIEF DESCRIPTION OF DRAWINGS

FIG. 1 is a block diagram schematic of the overall invented system.

FIG. 2 illustrates an exemplary embodiment of the DC-AC unit with the feedback voltage regulator and the control unit.

FIG. 3 illustrates an exemplary graph of the voltage-current relationship for NMOS solid state switch.

FIG. 4 illustrates an exemplary graph of the relationship of the power loss verses the current across a NMOS switch at different overdrive voltages.

FIG. 5 illustrates an exemplary embodiment of the two DC-DC converters that regulate and control the rail-to-rail voltages for the switches of the DC-AC inverter.

FIG. 6 illustrates an exemplary embodiment of a Buck converter in a feedback loop to regulate and control the voltage during the positive half cycle

FIG. 7 illustrates an exemplary chart for the positive half cycle Buck's converter power conduction loss using the ideal switch model, the piece-wise linear model and the experimental measurement of the exemplary embodiment described in FIG. 6.

FIG. 8 illustrates the experimental and ideal regulated positive half wave voltage of the DC-DC converter.

FIG. 9 illustrates an exemplary embodiment of a Buck converter in a feedback loop to regulate and control the voltage during the negative half cycle.

FIG. 10 illustrates an exemplary embodiment of a multilevel positive voltage Buck converter with n-array of series capacitors and their associated switches.

FIG. 11 illustrates an exemplary embodiment of a feedback loop of multilevel Buck converter and its triggering pulses associated with each switch.

FIG. 12 illustrates an exemplary chart for three levels DC-DC Buck converter with three voltage levels and conduction time intervals using ideal switches and practically linearized switches.

FIG. 13 illustrates an exemplary embodiment of de-multiplexing the conduction time intervals of the triggering pulses for multilevel Buck converter of FIG. 10.

FIG. 14 illustrates an exemplary embodiment of a multilevel negative voltage Buck converter with n-array of series capacitors, their associated switches and the feedback control loop.

### DESCRIPTION OF EMBODIMENTS OF THE INVENTION

The details of this invention that are indicated in the background as well as the description herein are identified for the purpose of providing an in depth and detailed understanding of this invention. It should be clear that the exemplary embodiments may be practiced without these specific details that are described in those embodiments. In other instances, the use of the type of switches, amplifiers, and components are not limited from the ones that are shown in diagrams to facilitate the description of the exemplary embodiments. The exemplary embodiments are used herein for the purpose of illustrating certain details of this invention; especially the use of the Buck converter as an exemplary embodiment of the DC-DC converters. However, the drawings should not be taken as imposing any limitations that may be present in the drawings. The embodiments may be implemented using an existing computer processor, or by a special purpose computer processor incorporated for this or another purpose, or by a hardwired system.

Technical effects of the method disclosed in the embodiments include enabling the production of single phase as well as three phase inverters that require fewer power devices and electronics while maintaining harmonics free output voltage at the load with minimum power losses. This allows for the reduction in size, weight and costs, at higher power level which is particularly advantageous for renewable energy and photovoltaic applications.

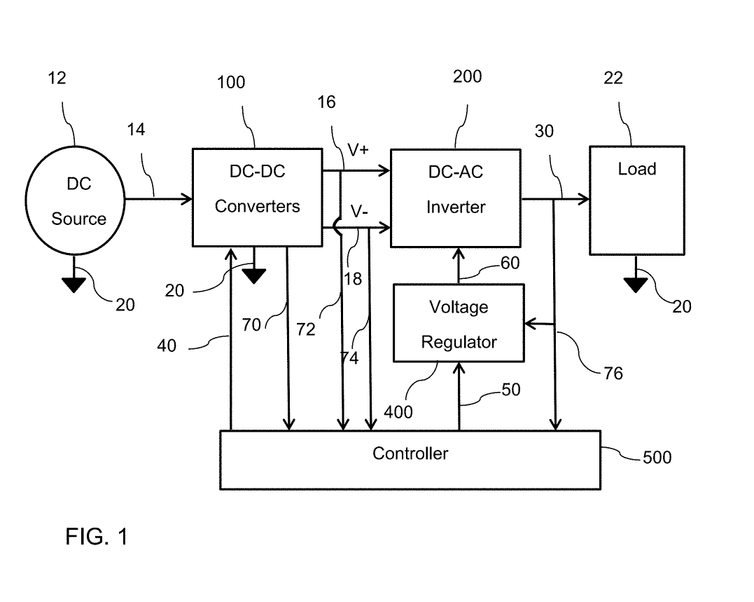

FIG. 1 illustrates a block diagram schematic of the invented DC to AC inverter 10 for single phase system, but this invention can be applied to three phase systems. The invented DC to AC inverter 10 includes unregulated dc voltage source 12, such as a battery, fuel cell, photovoltaic solar panel, DC grid or any other DC voltage source. The system has well defined ground node (neutral node) 20. The ground 20 is the same node throughout the entire system, at the DC-DC converters 100 and the Load 22, unless isolating grounding is used. The DC source 12 supplies an unregulated DC voltage 14 that may be a positive single line DC voltage or a two lines DC voltage source where one line is positive and the other line is negative. The unregulated DC voltage 14 is sent to the DC-DC converters 100. The DC-DC converters 100 generate two regulated voltages, V₊ 16 and V₋ 18, using any two DC-DC topologies that are suitable for the voltage levels of the unregulated DC voltage 14 as well as the desired regulated voltages V₊ 16 and V₋ 18. The DC-DC converters 100 provide regulated voltages by receiving pwm control signals 40 from the control unit 500 to the solid state switches of the DC-DC converters 100. The control signals 40 use pwm pulses which are rectangular pulses that are varied by the duty cycle and frequency to meet the demands of the regulated voltages V₊ 16 and V₋ 18 at different loads. The control unit receives voltage and current measurements 70, 72 and 74 from the DC-DC converters 100 as well as the regulated voltages measurements V₊ 16 and V₋ 18. The DC-AC inverter 200 converts the regulated DC voltages V₊ 16 and V₋ 18 to a harmonics free sinusoidal voltage at the load 30. The DC-AC inverter 200 receives precise triggering pulses 60 from the voltage regulator circuitry 400, and the triggering pulses 60 accommodate for the biasing required to turn on the solid state switches such that the output voltage at the inverter 30 is harmonics free sinusoidal voltage. This technique may be applied to a single phase system, to three phase system or to a poly-phase system. The voltage regulator 400 is responsible for sending a precise triggering pulse 60 to the DC-AC inverter 200. The voltage regulator 400 uses a voltage feedback loop that compares the measured output voltage 76 of the DC-AC inverter 200 to a desired reference sinusoidal signal, where the reference signal is generated from the triggering pulse 50 that comes from the control unit 500. The control unit may generate the desired reference signal at 60 Hz, 50 Hz, 400 Hz or any other frequency by generating a rectangular pulse at the desired frequency such that the pulse's amplitude and width are used to control the amplitude and phase of the desired sine wave; hence, it is used to control the output voltage. The voltage regulator 400 uses a high order low pass filter to converts the rectangular pulse 50 to the desired sine wave signal. The low pass filter is responsible for removing all the harmonics from the rectangular pulse 50. A third order filter was found to be sufficient, but higher order filters may be used to eliminate all the undesired harmonics from the reference signal. The output of the voltage regulator 400 sends a precise triggering pulse 60 to the solid state switches of the DC-AC inverter. These switches may be MOSFETS, BJTs, IBJTs or any solid state power switches that are suitable for this application. In general, the triggering pulse 60 requires very low power. Hence, it is possible to step up the pulse's voltage using very low power step-up transformer, or multiple cascaded low power transformers, to a higher voltage level. Finally, the control unit 500 is used to control the overall operation. First, the control unit 500 determines the proper triggering signal 50 that is sent to the voltage regulator circuit 400 by measuring the output voltages and currents at the load 76. Second, the control unit 500 controls the regulated DC voltages V₊ 16 and V₋ 18 such that the conduction power loss across the switches of the DC-AC inverter 200 is minimized. Hence, the control unit adjusts the frequency and duty cycle of the pwm pulses that are sent to the DC-DC converters 100. Depending on the circuit topology of the DC-DC converters 100, the control unit may adjust the switching frequency according to the load's currents, such that at higher load current higher frequencies are used. Also, the duty cycle of the pwm pulses that are sent to the DC-DC converter 100 is used to regulate voltages V₊ 16 and V₋ 18. This technique is used to properly adjust the voltages across the solid state switches such that the power dissipation across the DC-AC inverter 200 is minimized.

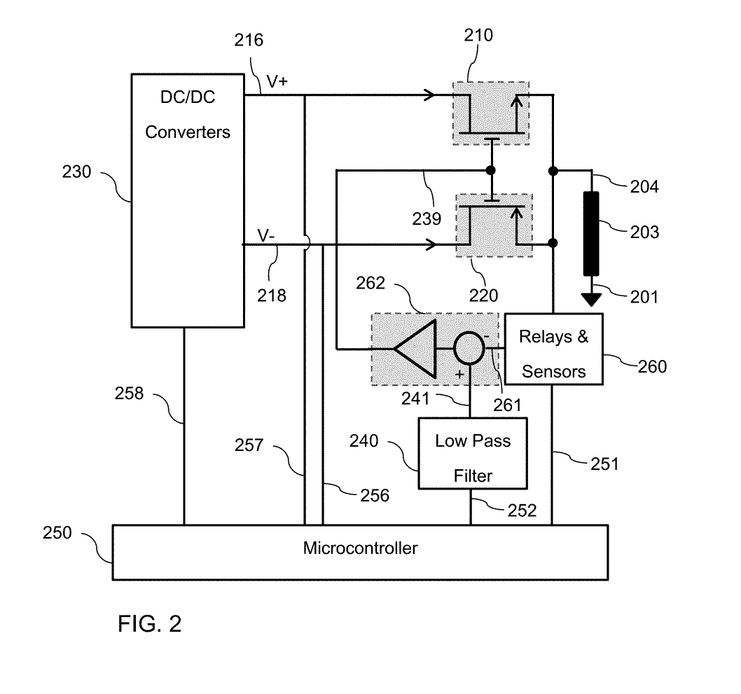

FIG. 2 illustrates an exemplary embodiment of a single phase DC-AC inverter with the feedback voltage regulator. The two complementary solid state switches, NMOS 210 and PMOS 220, are precisely triggered by the output of the feedback loop of the voltage regulator 239. The MOSFET solid state switches herein were chosen to assure that the gates' currents, which are supplied by the triggering pulse 239 of the voltage regulator, require very low power. However, any other complementary push-pull switching devices, such as PNP and NPN or IGBJTs, may be used as long as the output voltage 204 is controlled by sending a precise triggering pulse 239 of the feedback loop of the voltage regulator. Because the voltage-current relationship of a solid state switches of the DC-AC inverter, i.e. NMOS 210, is a function of the voltage of triggering pulse 239, and the load's voltage and current 204 as well as the regulated voltage V₊ 216, then the load voltage at 204 may be easily controlled by sending a precise triggering pulse 239 for a given voltage at V₊ 216. Here, the NMOS 210 is used as a voltage controlled device that permits the current to flow in the positive direction. The same reasoning is also used at the complementary device, i.e. PMOS 220. With a small difference that is the PMOS 220 passes the current in the opposite direction, a negative load current. The positive regulated voltage V+ 216 supplies V₊ the NMOS switch 210 with power during its conduction; similarly, the negative regulated voltage V− 218 supplies the PMOS switch with power during its conduction. The source terminals of each transistor are jointly connected at 204 to supply the load 203 with power. The voltage regulator may use a relays & sensors module 260 to sense and measure the load's voltage and the current 204 using a voltage divider network. Other techniques such as using relays can be used to measure the load's voltage and current 204; especially, in high voltage applications. The measured voltage at 262 is low enough to be handled by the electronic circuitry of the feedback amplifier 262. The feedback amplifier 262 uses a series-shunt negative feedback amplifier, where the sensed voltage at 273 is subtracted from the reference voltage 241. The difference of the two voltages, technically known as the error signal, is amplified using a forward path amplifier 262. It is possible to use a high voltage linear amplifier or a low power step-up transformer within the feedback amplifier 262 to increase the precise triggering pulse 239 to a higher voltage level. The microcontroller module 250 may contain multiple microcontrollers, any other computation devices or machines such as microprocessors, graphical processing unit (GPUs), computers or data acquisition systems. The microcontroller 250, or any other computational machine, generates a rectangular pulse 252 with a specific duty cycle at the load', or grid', desired frequency, typically it is 50 Hz, 60 Hz or 400 Hz. This rectangular pulse is passed through a low pass filter 240 to eliminate all higher order harmonics and to generate harmonics free sine wave at 241. This signal 241 serves as a reference signal for the linear feedback amplifier 262. A higher order filter may be used to eliminate all harmonics. The control unit 250 may control the amplitude of the reference signal 241 by adjusting the duty cycle of the rectangular generated pulse 252. The phase of the generated reference voltage in 241 is controlled by adjusting the rising edge time of the generated rectangular pulse 252. Hence, the controller may be synchronized output voltage 204 with the grid, in term of the phase and the amplitude of the output voltage. This is useful in renewable energy application such as solar energy and micro-grid systems. Basically, synchronizing the phase of the output voltage 204 to the grid is achieved by controlling the rising edge time of the rectangular pulse of 252, and the output voltage 204 is synchronized to the grid's rated voltage by adjusting falling edge time of the rectangular pulse 252. As a result, the controller measures the voltage and current at the load 204 by using relays and sensors network 260, which may include relays, voltage dividers, Hall current sensors and/or other sensing network topology. Those measurements 251 are converted into digital representation using analog-to-digital converter, typically they are built-in within the microcontroller 250. Those measured values are also used to control the DC-DC Converters 230 by sending the proper pulse width modulated (pwm) signals 258 to regulate the voltages V₊ 216 and V₋ 218. In this invention, the DC-DC converters 230 generate V₊ 216 and V₋ 218 such that the voltage across the solid state switches, i.e. NMOS 210 and PMOS 220, are optimized for minimizing the conduction power loss across those switches. In this invention, the conduction power loss is minimized by minimizing the voltages across the NMOS solid state switch 210 and the PMOS solid state switch 220 whenever they are conducting.

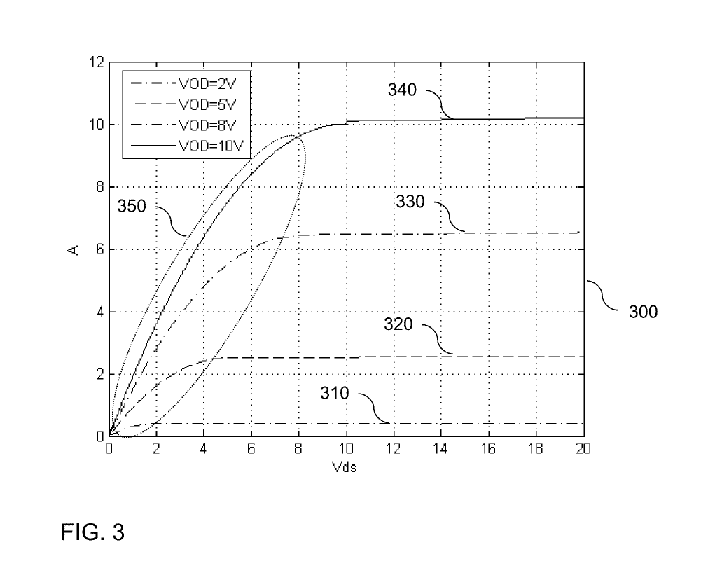

FIG. 3 illustrates an exemplary chart of the voltage-current relationship, V-I relationship, of a typical NMOS solid state switch. The NMOS switch's current is a function of the overdrive voltage (V_{OD}), the drain to the source voltage (V_{ds}) and the physical characteristics of the device such as the swich's doping and the size. The overdrive voltage is defined as the gate to the source voltage (V_{gs}) minus the threshold voltage (Vₜ), where the overdrive voltage is responsible for creating the conduction channel underneath the gate within the NMOS switch. Each particular switch has a maximum overdrive voltage that the device should not exceed. FIG. 3 shows different current curves as a function of the drain-source voltage at different overdrive voltages. The 310 curve shows the current in Amps verses V_{ds} when V_{OD}=2V. Note that the current changes linearly until V_{ds}≈V_{OD}. But if V_{ds} increases above V_{OD} the switch's current becomes saturated. Similarly, the other curves 320, 330 and 340 illustrate the switch's current at V_{OD} to be 5V, 8V and 10V, respectively. The linear region, defined by 350, is when the NMOS is used as switch in order to minimize the conduction power loss across the switch. The power dissipated by the switch is defined as P_{SW}=I_{SW}·V_{ds}. Because the switch's current does not increase in the saturation region and the current must not exceed the maximum current rating, then the voltage across the switch should be minimized at all times.

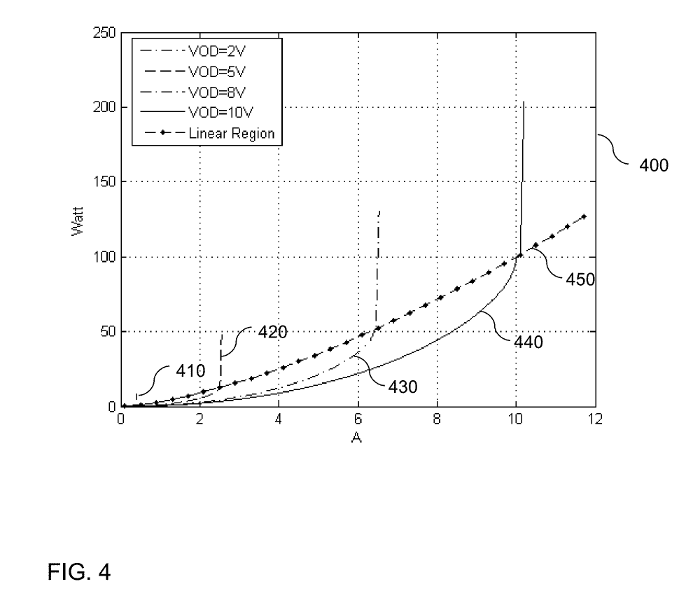

FIG. 4 illustrates an exemplary chart for the conduction power loss by the NMOS switch as a function of the current at different overdrive voltages. FIG. 4 shows the conduction power loss abruptly increases once the MMOs switch enters the saturation region. The curves 410, 420, 430 and 440 illustrate the currents at V_{OD} to be 2V, 5V, 8V and 10V, respectively. Also, the switch enters the saturation region, whenever current is above the linear region limit 450; hence, the switch must be operating in the linear region at all times. Similar analogy is used for the PMOS switch as well.

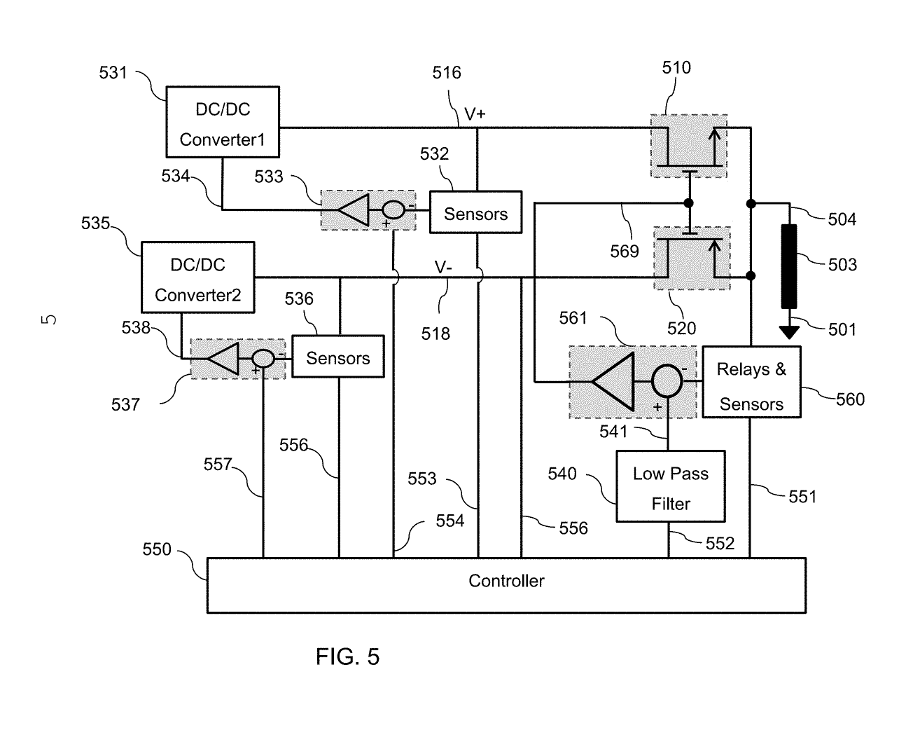

FIG. 5 illustrates an exemplary embodiment for using two DC-DC converters 531 and 535 with feedback loops 533 and 533, respectively. The two DC-DC converters are used to regulate the rail-to-rail voltages for the DC-AC inverter switches, 510 and 520, by controlling the positive voltage V+ 516 and the negative voltage and V− 518. The voltage control is done in such a way that it minimizes the voltages across the switches of the DC-AC inverter, 510 and 520. Hence, the power conduction power loss across the DC-AC switches is minimized. The first DC-DC Converter 1 531 regulates the positive voltage V+ 516 by comparing it to the referenced desired voltage 554. The difference 534, which is called the error signal, drives the switches of the DC-DC Converter1 531. The referenced voltage 554 is determined by the controller 550. The reference voltage 554 depends on the load's current and voltage at 504 and the voltage across the DC-AC inverter 510. Hence, the load's voltage and current 504 are measured using Relays & Sensors module 560 via the control signal 551. Once the referenced desired voltage 554 is determined by the controller 250, the difference, known as the error, between the reference voltage 553 and the actual voltage of the Sensors 532 is amplified in a feedback loop to generate the DC-DC Converter1 531 triggering pulse 534. The DC-DC Converter1 may be made of any topology such as Buck, Boost, Cuk, Buck-Boost, Push-Pull, Flying Back or any other suitable converter. Similarly, the negative voltage V− 518 is controlled via a feedback loop 537 which amplifies the difference between the measured negative voltage V− 518 using the Sensors module 536 to the referenced desired regulated voltage 557. The reference voltage 557 is generated by the controller 550 in order to minimize the conduction power loss across the DC-AC switch 520 during the negative half cycle of the load's current. The output signal 538 of the feedback amplifier 537 is used as the triggering pulse for the second DC-DC Converter2 535. The controller 550 need to compensate for the maximum rated currents of the DC-AC inverter switches 510 and 520 to generate the referenced desired voltages 554 and 557. Also, the latency time delay of the feedback amplifier should be as small as possible, or the feedback amplifier should be as fast as possible, so that the feedback system can react to the sudden change of the load's current at 504. Basically, the positive regulated voltage is going to be controlled such that the conduction power loss by DC-AC inverter's switch 510 is minimized. Likewise, the negative regulated voltage is going to be controlled such that the conduction power loss by DC-AC inverter's switch 520 is going to be minimized. This is achieved by varying the frequency and the duty cycle of the pwm of the DC-DC converters using negative feedback topology.

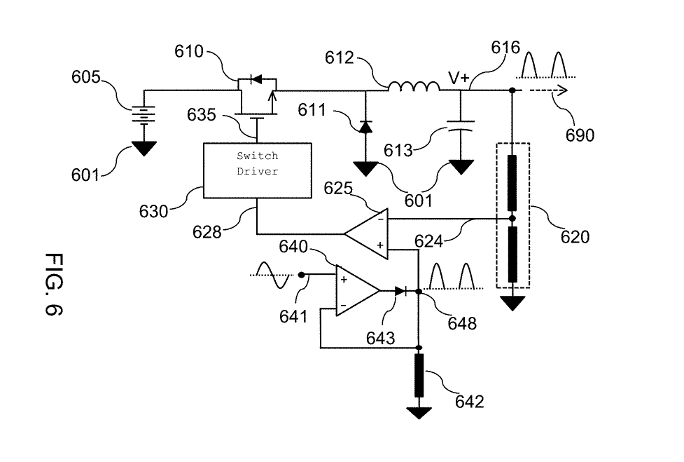

FIG. 6 illustrates an exemplary embodiment that uses a Buck converter in a feedback loop, but other converters such as Boost, Buck-Boost, Cuk or any other type may be used. The Buck converter is used to control and regulate the voltage V+ 616 during the positive half cycle. This embodiment may be implemented using discrete electronics, a single package as in VLSI chip, or a combination of discrete electronics and VLSI chips. The input power of the Buck converter is supplied by an unregulated dc voltage 605. The solid state switch 610 controls the voltage at the load 690 by adjusting the duty cycle of the gate's pulse 635. The inductor 612 is used to smooth out the current and absorb the voltage difference between the input voltage source 605 and the positive voltage V+ 612. Hence, the inductor stores the energy when the switch 610 is on, and it releases that stored energy to the load 690 and the capacitor 613 when the switch 610 is off. The diode 611, which may be a controlled switch, is used to allow the inductor's current 612 to flow when the switch 610 is off. The objective of this circuit is to regulate the positive voltage V+ 616 in the positive half cycle. The regulated voltage V+ 616 needs to be optimized to minimize the power dissipated by the DC-AC inverter switch 510 in FIG. 5. In this invention, the regulated voltage V+ is controlled by using a feedback amplifier 625, which amplifies the difference, also called the error, between the measured voltage at V+ 624 and the reference signal 648. The amplified error signal of the feedback amplifier 628 is the triggering pulse, and it is sent to switch driver 630. The switch driver 630 is a module that is used to trigger the solid state switch 610 of the Buck converter. A simple voltage divider network 620 is used to measure the regulated voltage V+ 616, but other topologies in combination with relays and low power transformers maybe used especially in high voltage applications. A referenced sine wave 641 is generated by the controller 550 of FIG. 5. The sine wave signal 641 is synchronized with the load voltage 505 in FIG. 5. This sine wave signal 641 is sent through a high precision half wave rectifier, but other circuits or systems may be used, by placing a diode 643 at the output of an OP-AMP 640 that is connected in a non-inverting configuration. The output signal 648 of the high precision half wave rectifier is the reference signal that is compared with the measured regulated voltage 624. It is possible to generate the half wave rectified signal 648 using digital circuits such as microcontroller, microprocessor and/or other programmable devices that have analog-to-digital converter with or without filters. In this invention, the regulated voltage V+ 616 is explicitly controlled by comparing it with a positive half wave referenced signal; where the referenced signals may be generated by any mean, digital or analog, where the difference, or the error, is used to control the triggering signal 628 of the Switch Driver 630. The objective using the Buck converter in this exemplary embodiment is to reduce the voltage across the DC-AC inverter's switch 510 in FIG. 5.

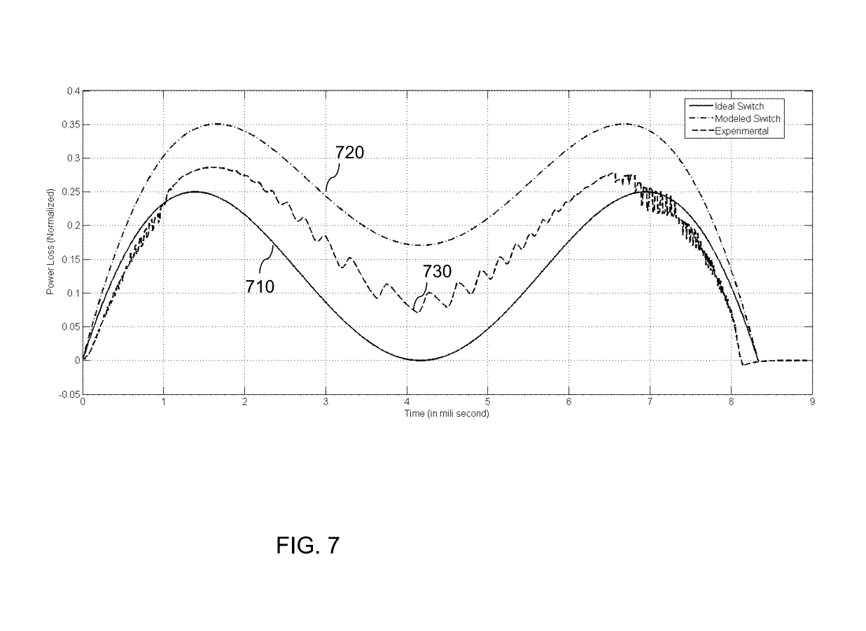

FIG. 7 illustrates the conduction power loss across the Buck converter switch 610 of FIG. 6. FIG. 6 illustrates the conduction power loss are using ideal circuit elements 710, the piece-wise linear model 720, and the experimental measurements 730. The deal conduction power loss 710 is caused by the voltage difference from the source to the load across the buck converter's switch 610. This ideal elements conduction power loss is caused by the voltage difference between the output and the input across the Buck converter solid state switch. The total power losses are found to be 21% of the total delivered power. On the other hand, when the switch and diode are modeled using the piece-wise linear model, the conduction power loss 720 was found to be higher due to the voltage drop across the switch and the diode during conduction. The power loss is found to be around 32%. This may vary based on the voltage-current characteristics of the solid state switch and the diode. The experimental power loss 730 is comparable to the linearly modeled switch power loss 720.

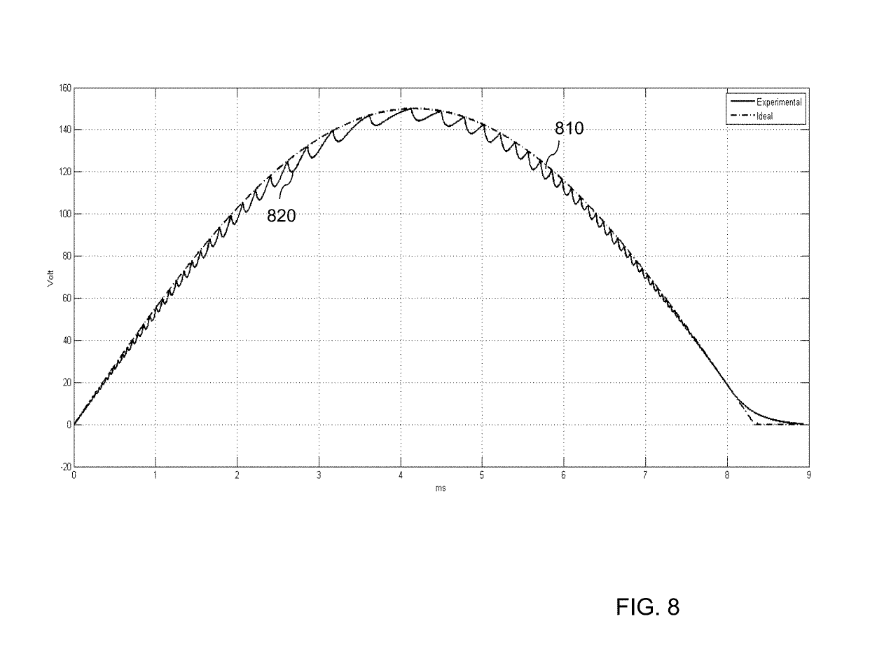

FIG. 8 illustrates a graph of the experimental regulated voltage V+ verses the ideal regulated voltage. It is clear that the experimental voltage 820 has ripples due to the latency of the switch driver module 630 and the feedback loop amplifier 625 of FIG. 6. This ripple was decreases by improving the speed of the switch driver and the latency of the amplifier.

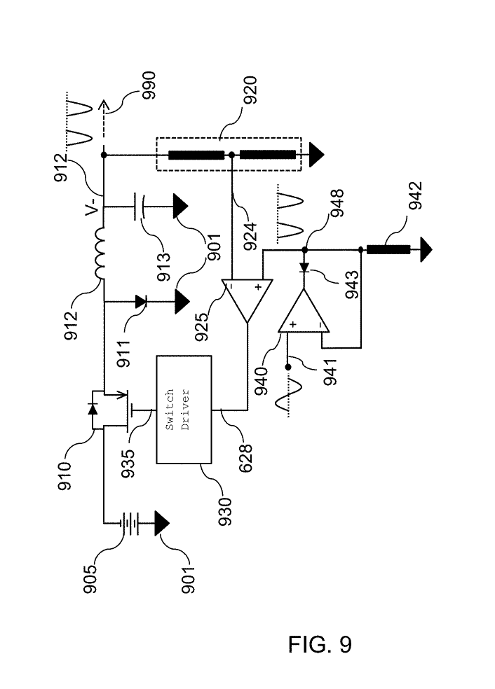

FIG. 9 illustrates an exemplary embodiment of a Buck converter with a feedback loop that regulates the negative voltage V− 918 during the negative half cycle. This module is similar to the one described in FIG. 6 with the exception that it is used to regulate the negative voltage V− 918. This voltage corresponds to the regulated voltage V− 518 in FIG. 5. The Buck converter has unregulated negative voltage source 905 that supplies the load 990 with the required power during the negative half cycle. In this invention, the regulated negative voltage 918 is controlled such that the voltage across the DC-AC inverter switch 520, shown in FIG. 5, is optimized to minimize the conduction power loss across the switch. The circuit shown in FIG. 9 uses Buck DC-DC converter, but other type of converters such as Boost, Cuk, Buck-Boost or any other type of inverters maybe used as long as the regulated negative voltage V− 918 is controlled using feedback loop to control the voltage across the DC-AC inverter's switch 520, shown in FIG. 5. The Buck converter in FIG. 9 has a P-type solid state switch 910. Here a PMOS switch is used, but other type of switches such as BJTs or IGBJT may be used. The solid state switch 910 allows the current to sink into the negative voltage source 905. The inductor 912 is used to smooth out the load's current and to absorb the voltage difference from the source 905 to the regulated voltage V− 918. The inductor stores the energy when the solid state switch 910 is conducting, and it releases that stored energy when the solid state switch 910 is off. The diode 911 permits the inductor's current 912 to flow when the switch 910 is off. The capacitor 913 is used to filter out the voltage ripple at the load 990 making that voltage to be smooth. Just as the positive regulated voltage V+ 616 illustrated in FIG. 6, the negative regulated voltage V− 918 is measured using a voltage divider network 920, but other networks uses relays and/or sensors and/or transformers maybe used. The measured voltage 924 is compared with the desired reference negative voltage 948 and sent through a feedback amplifier to generate a triggering pulse 928 that derive the switch driver 930.

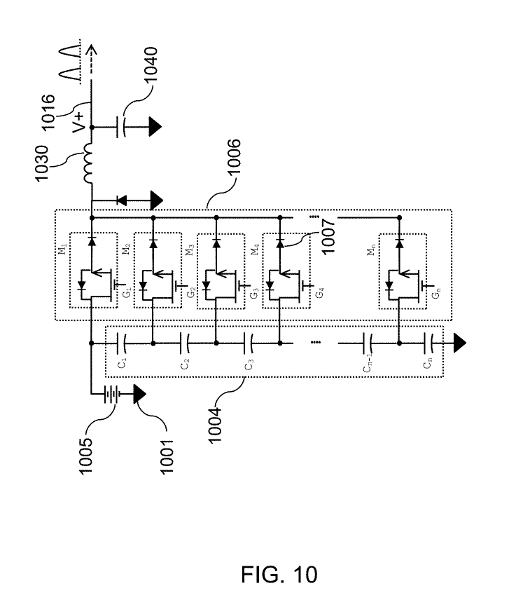

Now that the conduction loss across the DC-AC inverter switches 510 and 520 of FIG. 5 are optimally reduced, the conduction power loss across the DC-DC converters must be optimally reduced as well. In this invention, the conduction power loss across the switches of the DC-DC converters are minimized by adjusting the voltage across their switches. This is done by applying multilevel steps voltages across the switch such that the overall conduction power loss is minimized. FIG. 10 illustrates and exemplary embodiment on how to generate a positive half wave regulated voltage V+ using multilevel Buck converter. The multilevel voltages are created using an array of series voltage sources such as an array of capacitors 1004 that are connected in series. The voltage across the j^{th} capacitor is found to be Vⱼ=(C_{T}/Cⱼ)V_{T}, where V_{T} is the total voltage supplied by the source 1005 and C_{T} is the total equivalent capacitance. The array of capacitors 1004 generates multilevel voltages at the top of each capacitor. Each voltage level is associated with a dedicated solid state switch. Each switch conducts during a specific conduction interval that is precisely determined to optimally minimize the conduction power losses. Hence, there is an array of solid state switches 1006 where each switch is associated with one of the array capacitors 1004. Because most high power solid state switches are bidirectional, a diode is connected in series with each solid state switch to block the current from flowing in the reverse direction. For example, diode 1007 is connected in series with switch 4 to block the current from flowing backward in the reverse direction. Also, each solid state switch has a triggering pulse that forces the switch to conduct over a specific interval. The triggering gate pulse of each switch has its own duty cycle which depends on the input voltage level and the output desired voltage. The duty cycle is adjusted so that the positive regulated voltage V+ 1016 is half wave rectified. The inductor 1030 absorbs the voltage difference between the input voltage source and the regulated voltage at V+ 1016. As in conventional Buck converters, the capacitor 1040 at the regulated voltage V+ 1016 is used to stores the charges during the ON time of the duty cycle and supply the load at 1016 with current during the OFF time.

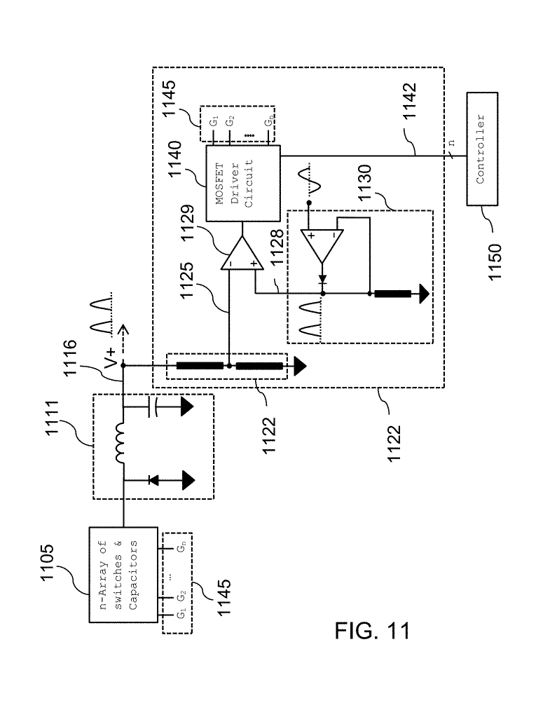

FIG. 11 illustrates and an exemplary embodiment of the feedback control module with switches driver module 1120 that send the triggering pulses 1145 to the n-array of switches 1105. The array of switches is the same as 1006 of FIG. 10. The diode, inductor and capacitor module 1110 are the same as the ones used in conventional buck converters and similar to the ones of FIG. 6. The regulated voltage V+ at 1116 is measured using a step-down voltage divider network 1120, but any other network type such as relay and transformers may be used. The measured signal 1125 is compared to the desired signal 1128 and it is amplified using a feedback amplifier 1129. The desired signal 1128 is generated using a high precision half wave rectifier 1130, or any other topology may be used. The output of the feedback amplifier generates a non-linear pwm signal that is sent to the switches driver module 1140. Only one switch is turned ON at a time by enabling one of the triggering pulses 1145, one of the G₁, G₂, . . . , Gₙ pulses, at a time. Each triggering pulse conducts over a non-overlapping interval that is precisely chosen such that the conduction power loss is minimized. The controller 1150 sends the n control signals 1142, which enables one of the switches at a time.

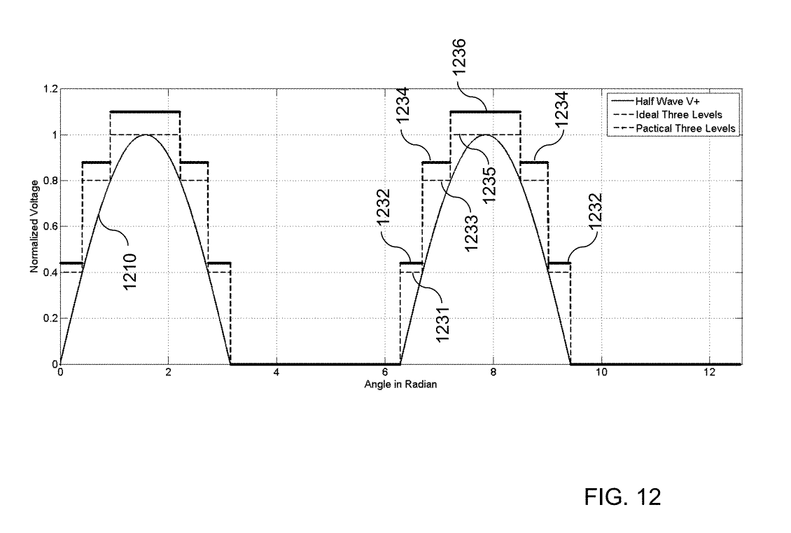

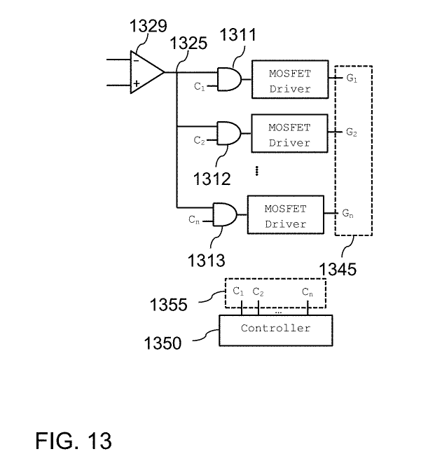

FIG. 12 illustrates and an exemplary graph of a three level Buck converter as the one that is described in FIG. 10 and FIG. 11. In this exemplary graph, there are three voltages V₁, V₂ and V₃ that are associated with three switches such that V₁>V₂>V₃. The voltage levels are evaluated using exhaustive search algorithm that is conditioned to minimize the conduction power loss for the three levels. The exhaustive search algorithm determines the voltage level and their corresponding conduction time intervals that are associated with each level. Hence, the voltage value depends on the number of levels used. The higher the number of levels used the smaller the conduction power loss. This comes at higher costs and complexity at higher levels. The levels are initially determined using ideal switches, MOSFETS and Diodes, and then they were adjusted to compensate for the voltage drops across the switches. Using the ideal switches, the voltage for V₃ 1231, V₂ 1233 and for V₁ 1235 and their associated conduction time intervals are initially determined. The conduction time intervals are quarter wave symmetrical around the peak value at π/2. Then, those voltage level values are adjusted to compensate for the voltage drop across the switches. The voltage drop depends on the load current and the physical characteristics of the device. Hence, actual voltage for V₃ 1232 is increase from the ideal voltage 1231. Also, the actual voltage for V₂ 1234 is increased from the ideal voltage 1233 and for V₁ 1236 that is increased from the ideal voltage 1235. The increase in the voltage level values is determined once the physical characteristics of the switches and the load current become known. The controller 1150 of FIG. 11 determines which switch will be conducting based on the conduction time interval. FIG. 13 illustrates an exemplary embodiment of the switches' drivers with their corresponding control signals. This exemplary module contains n control signals 1355 which are sent by the controller 1350. Each of those control signals 1355 defines the conduction time interval for its associated gate triggering switch. The triggering pulse signal 1325, which carries the duty cycle that regulates the voltage, is generated by the feedback amplifier 1329. The feedback amplifier is the same as 1129 of FIG. 11 which amplifies the error difference between the desired half wave positive voltage 1128 and the measured positive regulated voltage 1125 of FIG. 11. The triggering signal 1325 is de-multiplexed to its designated switch using the control signals 1355. The basic function of the de-multiplexer is to trigger each gate switch 1345 during its associated conduction interval. One way to implement the de-multiplexing is to assert one of the control signals 1355 to logic “1” during its associated switch conduction time interval, but all other control signals 1350 are asserted to logic “0”. Then, an AND gate is used to pass the triggering pulse 1325 to its associated switch driver.

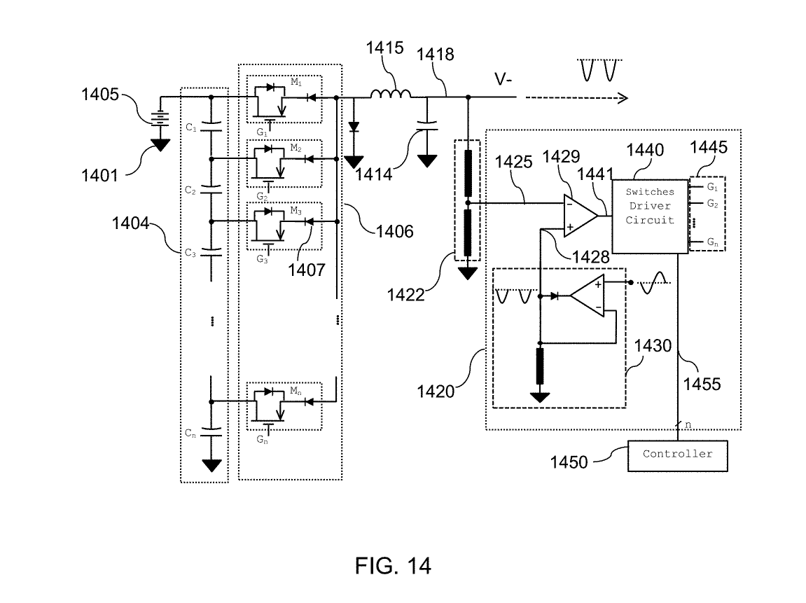

FIG. 14 illustrates and exemplary embodiment on how to generate a negative half wave regulated voltage V− 1418 using multilevel Buck converter with its feedback control module. This exemplary embodiment uses the Buck DC-DC converter but any other DC-DC converter maybe used. The multilevel voltages are created using an array of series voltage sources or an array of capacitors 1404 that are connected in series. The voltage across the j^{th} capacitor can be found as Vⱼ=(C_{T}/Cⱼ)V_{T}, where V_{T} is the total negative voltage supplied by the source 1405 and C_{T} is the total equivalent capacitance. The array of capacitors 1404 generates multilevel negative voltages at the top of each capacitor. Each voltage level is associated with a dedicated solid state switch, PMOS switch is used here. Each switch conducts during a specific conduction interval that is precisely determined to optimally minimize the conduction power losses. Hence, there is an array of solid state switches 1406 that associated with each of the capacitors of the array of capacitors 1404. Because most high power solid state switches are bidirectional, a diode is connected in series with each solid state switch is used to block the current from flowing in the reverse direction. For example the diode 1407 is connected in series with switch 3 to block the current from flowing in the reverse direction. Also, each solid state switch has a triggering pulse that forces the switch to conduct over a specific interval. The triggering pulse for each switch has its own duty cycle which depends on the input voltage level and the output desired voltage. The duty cycle is adjusted so that the negative regulated voltage V− 1418 is half wave rectified. The inductor 1415 absorbs the voltage difference between the input voltage source and the negative regulated voltage at V− 1418. The capacitor 1414 at the regulated negative voltage V− 1418 is used to stores the charges during the ON time of the duty cycle and supply the load at V− 1418 with current during the OFF time of the pwm. The feedback loop unit 1420 with switches driver module 1440 that sends the triggering pulses 1445 to the n-array of switches 1406. The regulated negative voltage V− 1418 is measured using a step-down voltage divider network 1422, or any other network type such as relay and/or transformer. The measured signal 1425 is compared to the desired signal 1428 and it is amplified using a feedback amplifier 1429. The desired signal 1428 is generated using a high precision negative half wave rectifier 1430. The output of the feedback amplifier 1441 generates a non-linear pwm signal that is sent to the switches' driver module 1440. Only one switch is turned ON at a time by enabling one of the triggering pulses 1445, the G₁, G₂, . . . , Gₙ pulses, at a time. Each triggering pulse conducts over a non-overlapping interval that is precisely chosen such that the conduction power loss is minimized. The controller 1450 sends the n control signals 1455, which enables one of the switches at a time.

This written description uses detailed examples to relate to the invention to enable any person or entity, who is skilled in the field to practice the invention. That includes the making and the use of any device, subsystem or system as well as performing any incorporated methods. The patentable scope of the invention is defined by the claims, and may include other examples that occur to those skilled persons. Such other examples are intended to be within the scope of the claims if they have structural elements that do not differ from the literal language of the claims, or if they include equivalent structural elements with insubstantial differences from the literal languages of the claims.

What is claimed is:

1. A highly efficient harmonics free DC to AC inverter system that includes unregulated DC voltage source, that may be supplied by a battery or photovoltaic cells or any unregulated voltage source, followed by multilevel voltage controlled DC-DC converters that produce positive half wave regulated sinusoidal voltage V₊ and negative half wave regulated sinusoidal voltage V, followed by a DC-AC inverter that is driven by harmonics suppressor voltage regulator in a feedback loop, in which the DC-AC inverter supplies the load with harmonics free sinusoidal voltage at rated values, and in which the overall system contains a controller that controls the multilevel DC-DC converters and the rated voltage based on the load current and power factor.

2. The DC-AC inverter of claim 1 uses a pair of push-pull solid state switches, such as NOMOS and PMOS switches, that are driven by precise triggering pulses in order to generate harmonics free voltage at the load.

3. The DC-DC converters of claim 1 generates two regulated voltages, V+ and V− , in such a way that minimizes the voltages across the pair of the push-pull solid state switches of DC-AC inverter of claim 1 by making V+ to follow the output voltage on the positive half cycle of the current, and by making V− to follow the output voltage on the negative half cycle of the current.

4. The feedback loop of voltage regulator of claim 1 wherein uses a harmonics free sine wave as a reference signal to regulate the voltage at the load by sending precise triggering pulses in the feedback loop to drive the push-pull solid state switches of the DC-AC inverters.

5. The control unit of claim 1 wherein uses a computation machine, such as microcontroller or microprocessor and/or analog systems with or without feedback topologies, to the control the entire system by sending control signals to drive the switches of the DC-DC converters, the voltage regulator and the DC-AC inverter.

6. The combined coupling of the voltage regulator and the push-pull solid state switches of the DC-AC inverter of claim 1 wherein are used in a feedback configuration to provide harmonics free sine wave voltage at the output.

7. The feedback loop voltage regulator of claim 1 wherein uses a low power step-up transformer or a sequence of cascaded transformers or high voltage electronics or any other electronics device to step up the triggering pulses of the push-pull solid state switches so that it generates harmonics free voltage at the output.

8. A method for generating a highly efficient DC-AC inverter with minimum power conduction loss across the push-pull solid state switches of the DC-AC inverter is obtained by applying the maximum allowable triggering signals at the gates of the switches while minimizing the voltage across the push-pull solid state switches of the DC-AC inverter by using two DC-DC converters, such as Buck DC-DC converters or any other DC-DC converter, where one converter generates a regulated positive half cycle voltage V+ by using a non-linear pwm via feedback loop, or other mechanism, that generates precise pwm pulses to the driver circuit of the positive voltage converter, and the other converter generates a regulated negative half cycle voltage V− by using non-linear pwm via feedback loop, or other mechanism, that generates the pwm pulses to the negative converter switch driver.

9. The inductors and capacitors of the converters, such as Buck or Boost or Buck-Boost or Cuk or other types of converters, of claim 8 wherein are selected to make the converters operate in the continuous mode for a large range around the nominal rated current.

10. The regulated voltages V+ of claim 8 wherein uses a high gain and high bandwidth amplifier in the feedback which measures the regulated voltage V+ and compares it with a referenced half wave sinusoidal signal so that the regulated voltage V+ follows the voltage across the DC-AC inverter switch such that the conduction power loss of the DC-AC inverter is minimized during positive half cycle of the of the current.

11. The regulated voltages V− of claim 8 wherein uses a high gain and high bandwidth amplifier in the feedback which measures the regulated voltage V1 and compares it with a referenced half wave sinusoidal signal so that the regulated voltage V− follows the voltage across the DC-AC inverter switch such that the conduction power loss of the DC-AC inverter is minimized during negative half cycle of the of the current.

12. This invention includes two highly efficient multilevel DC-DC converters, where one converter is used to generate a regulated positive voltage V+ during the positive half cycle and the other converter is used to generate a regulated the negative voltage V− during the negative half cycle, where each multilevel converter has an array of series connected capacitors, that act as voltage sources in series, and each capacitor is connected to its associated switch in series with a diode, where the diodes are used to prevents the flow of reversed currents, also each switch has its own driver circuit that is driven by a feedback amplifier in a feedback loop, where one feedback loop is used to regulate the positive voltage V+ of the converter and the other feedback loop is used to regulate the negative voltage V− of the converter, and both converters have control signals that determine the conduction time interval for each switch.

13. The positive voltage multilevel DC-DC converter of claim 12 wherein generates a regulated positive half wave sinusoidal voltage that optimally minimizes the voltage across the push-pull switches of the DC-AC inverter during the current's positive half cycle.

14. The negative voltage multilevel DC-DC converter of claim 12 wherein generates a negative half wave sinusoidal voltage that optimally minimizes the voltage across the push-pull switches of the DC-AC inverter during the current's negative half cycle.

15. Each of the capacitors of claim 12 wherein is carefully selected based on the number of levels selected, so that the conduction power loss across the multilevel DC-DC converter is minimized.

16. Each switch of claim 12 wherein is conducting during a specific time interval that is determined such that the overall power loss across the DC-DC converter is minimized.

17. The duty cycle of the pwm signal for each switch of the multilevel DC-DC converters of claim 12 wherein is controlled during its conducting time interval using a high speed amplifier in the feedback loop, or other mechanism such as precise algorithm.

18. The feedback loop for each of the multilevel converters of claim 12 wherein uses a half wave rectified signal that is generated by the controller and compares it to the actual measured voltage to derive the pwm duty cycle of each switch during the switch conduction time interval.

19. The voltage step size and the conduction time intervals for each switch of claim 12 wherein are determined by finding the global minima of the conduction power losses across the converters using exhaustive search iterative numerical methods.

20. Each switch of the multilevel converter of claim 12 wherein has a series connected diode that prevents the current from flowing backward in the reverse direction as those switches are bidirectional.
